(19) United States
(12) Patent Application Publication
(10) Pub. No.: US 2008/0135711 A1
(43) Pub. Date: Jun. 12, 2008

(54) Food Serving Device with Suspended Serving Utensil

(75) Inventor: Tracy Y. Bunting, Wilson, NC (US)

Correspondence Address: COATS & BENNETT, PLLC, 1400 Crescent Green, Suite 300, Cary, NC, 27518, US

(73) Assignee: TRACY AND ASSOCIATES REAL ESTATE, INC., Wilson, NC (US)

(21) Appl. No.: 11/567,416

(22) Filed: Dec. 6, 2006

(51) Int. Cl. A47G 23/08; A47J 43/28; B65D 85/00; B65D 1/34

(52) U.S. Cl. 248/328; 30/327; 206/553

(57) ABSTRACT

A food serving device suspends a serving utensil so that the handle thereof is kept from falling into the food, while allowing use of the serving utensil for its intended function. The device may include a base having an upper surface having at least a food container station; an upper support; a serving utensil having a food serving end and a handle; an elastic element suspended from the support and extending generally downward therefrom that moveably couples the utensil to the support and is elastically stretchable. The elastic element supports the serving utensil in a suspended fashion such that, with the elastic element in the relaxed state, the handle is suspended in so as to be farther from the base upper surface than the serving end. Advantageously, the serving utensil is generally vertically oriented when supported by the elastic element in the relaxed state.

### BACKGROUND

The present invention relates to a food serving device, and more particularly to a suspended food serving utensil particularly useful for self-service style food bars such as salad and hot food bars.

Many restaurants have salad or other food bars where customers serve themselves using various serving utensils (tongs, large spoons, and the like). These utensils may sometimes fall into the food, with the result that the serving utensil's handle becomes dirty. In addition, the customers directly handle these serving utensils, and not all customers are fastidious about their hygiene. Thus, direct contact between the serving utensil's handle and the food may contaminate the food. Further, customers have a tendency to leave the serving utensils in random locations when they are finished serving themselves. This combination of circumstances is less than ideal.

Thus, there remains a need for controlling the disposition of serving utensils that are used in conjunction with food bars.

### SUMMARY

The invention provides a food serving device that suspends the serving utensil so that the handle section of the serving utensil is kept from falling into the food, while still allowing use of the serving utensil for its intended function. In one embodiment, the present invention provides a food serving device comprising: a base having an upper surface having at least a first food container station; a upper support disposed above the first food container station by a first distance; a first serving utensil corresponding to the first food container station and having a distal food serving end section and a proximal handle section; a first elastic element suspended from the support and extending generally downward therefrom; the first elastic element moveably coupling the first serving utensil to the upper support; the first elastic element elastically stretchable from relaxed state to a stretched state in response to a user pulling thereon; wherein the first elastic element supports the first serving utensil in a suspended fashion such that, with the first elastic element in the relaxed state, the handle section is suspended in spaced relation from the base upper surface so as to be farther from the base upper surface than the serving end section. There may be multiple utensil assemblies corresponding to multiple food serving stations. The serving utensil may be a solid serving spoon, a perforated serving spoon, a fork, a ladle, tongs, or the like. The utensil assembly may comprise a magnetic mount removably coupling the elastic element to the upper support. There may be a releasable coupler operatively disposed between the elastic element and the serving utensil. Advantageously, the serving utensil is generally vertically oriented when supported by the elastic element with the elastic element in the relaxed state.

Other aspects of various embodiments of the inventive device and related methods are also disclosed in the following description.

### BRIEF DESCRIPTION OF THE DRAWINGS

FIG. 1 shows a food service device according to one embodiment of the present invention in the form of a food bar.

FIG. 2 shows a closer view of the embodiment of FIG. 1, with the utensil assembly in the relaxed, ready position.

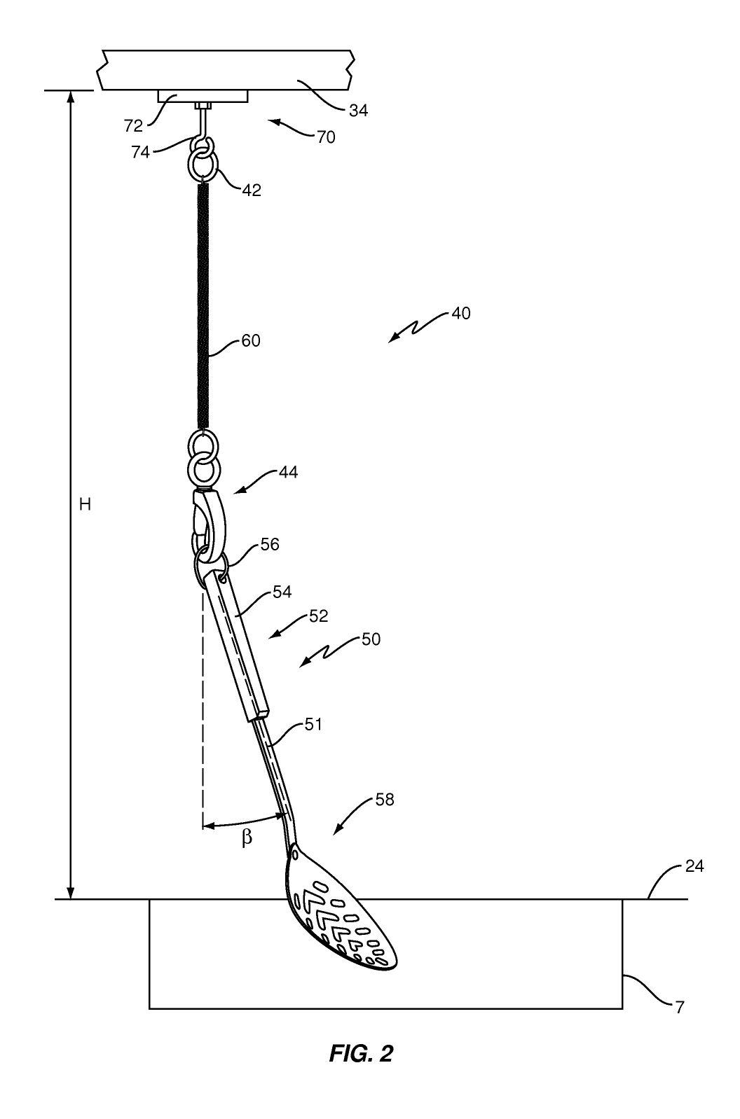

FIG. 3 shows a closer view of the embodiment of FIG. 1, with the utensil assembly being used to serve food by a user, with the elastic member in an extended state.

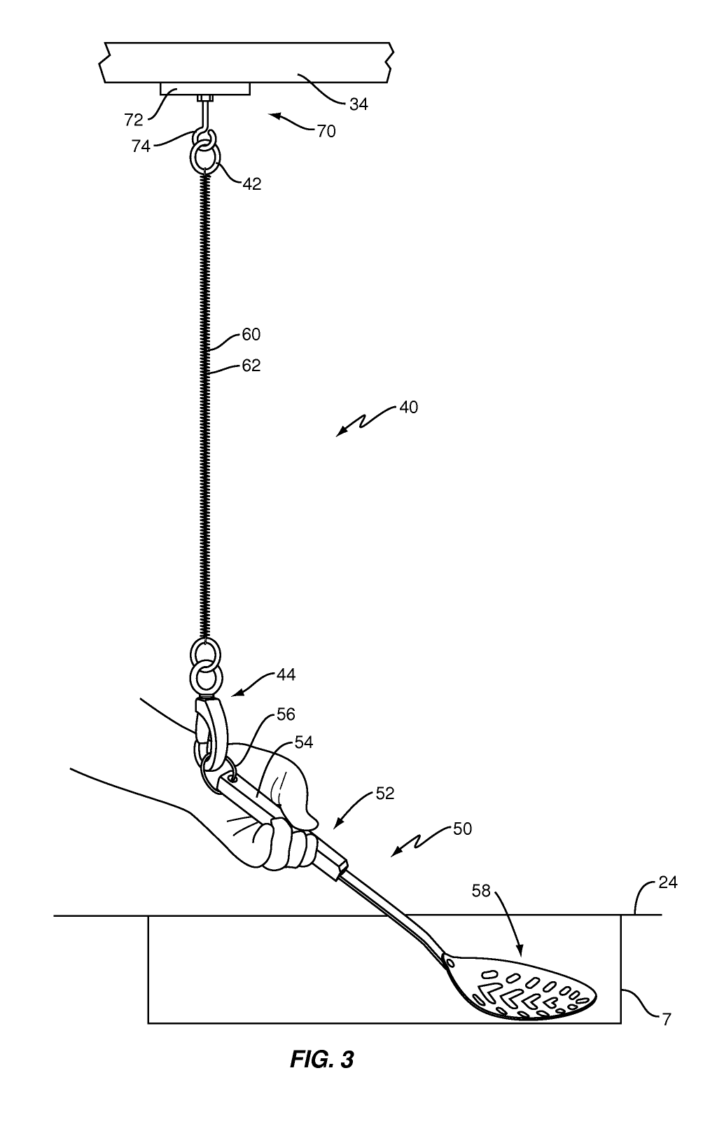

FIG. 4 shows another embodiment of the present invention, with the utensil assembly in the relaxed, ready position.

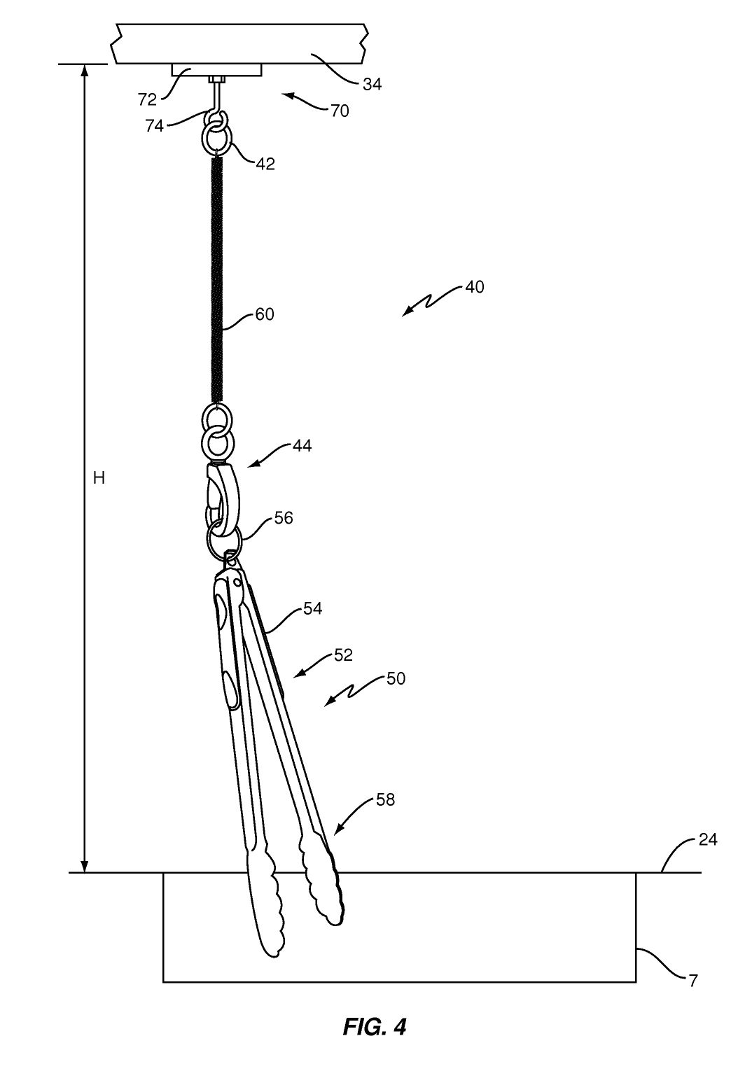

FIG. 5 shows another food service device according to another embodiment of the present invention in the form of a chafing dish.

FIG. 6 shows another utensil assembly embodiment wherein multiple utensils are supported from a common mount.

### DETAILED DESCRIPTION

The present invention relates to a food serving utensil 50, such as a spoon, fork, and the like typically found at a self-service food bar 20. The invention is intended to help keep the handle of the serving utensil 50 from falling into the food, while still allowing use of the serving utensil 50 for its intended function.

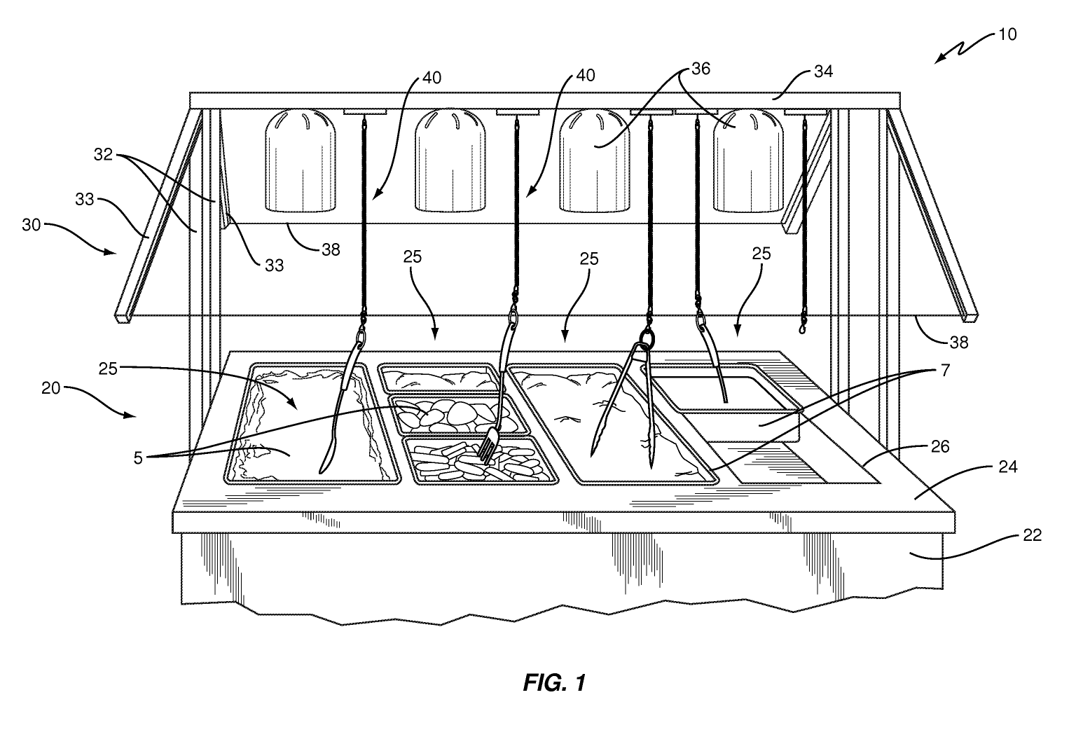

A food serving device according to one embodiment of the present invention is shown in FIG. 1, and generally indicated at 10. The food serving device 10 includes a conventional food service bar 20 and one or more utensil assemblies 40. The conventional food service bar 20 may take any form known in the art. For the embodiment illustrated in FIG. 1, the food bar 20 includes a base 22 and a superstructure 30. The base 22 is typically generally rectangular in shape, although any shape known in the art may be used. The upper surface 24 of the base 22 includes a plurality of food container stations 25 for receiving various food trays 7. The upper surface 24 may advantageously include a hole 26 for receiving corresponding food trays 7 at each food container station 25; however, such is not required. Indeed, the upper surface 24 may simply be a flat surface, with the food tray(s) 7 placed at one or more food container stations 25 on the surface 24. The superstructure 30 extends above the base 22 and is typically supported thereby. The superstructure 30 typically includes a pair of arms 32, a cross-member 34, and a pair of shields 38. The arms 32 extend generally vertically upward from the base 22, and may take the form of conventional box channel or tubular posts. The arms 32 may include laterally extending flanges 33, if desired, for attachment of “sneeze” shields 38, as discussed below. The cross-member 34 is disposed generally horizontally across the longitudinal length of the base 22, so as to overlie the food container stations 25. Typically, the cross-member 34 is much narrower than the base 22, and is disposed along the longitudinal midline thereof. One or more optional warming lights 36 may be attached to the underside of the cross-member 34. These warming lights 36 are used to help keep food 5 in the food containers 7 warm when appropriate. The warming lights 36 are typically spaced from one another, and may advantageously be aligned with the food container stations 25. The shields 38 are typically generally planar sheets made from a clear plastic material. The shields 38 may attach to flanges 33 on arms 32 and/or to cross-member 34, and typically extend at a downward angle away from the cross-member 34.

The utensil assemblies 40 include a serving utensil 50, an elastic element 60, and an optional mounting assembly 70. The serving utensil 50 may take a variety of forms depending on the desired function. For example, the serving utensil 50 may be a solid spoon type, a perforated spoon type, a fork type, a ladle type, a tong type, or the like, depending on what type of food 5 the serving utensil 50 is intended to be used with. Regardless of the particular serving utensil type, the serving utensil 50 is an elongate body with a handle section 52 and a serving end section 58. The user holds the serving utensil 50 by the handle section 52 during use. Accordingly, the handle section 52 may advantageously include a grip 54, such as an elastomeric grip, of increased cross-sectional size. The handle section 52 may further include a ring 56, which may extend through a suitable hole in handle section 52; this ring 56 may be used for hanging and/or suspending the utensil 50 as described further below. The serving end section 58 may take a variety of forms suitable for the intended task of engaging the food 5 during use. For example, when the serving utensil 50 is of the spoon type, the serving end section 58 may take the form of a shallow curved plate-like structure. This plate-like structure may be solid for a conventional spoon, or may have a plurality of holes or slots therein for a “draining type” spoon, etc. As another example, when the serving utensil 50 is of the tongs type, the serving end 58 section comprises a pair of flat or spoon-shaped sections that move toward and away from each other.

The elastic member 60 is also elongate, and typically takes the form of a coil-type extension spring. The elastic element 60 couples to handle section 52 of the serving utensil 50, advantageously via a releasable coupling 44. For example, the elastic element 60 may attach to the handle section 52 via ring 56 and a suitable gated clip 44. Advantageously, the gated clip 44 allows relative rotation of the elastic element 60 and the serving utensil 50, such as by being a swiveling eye bolt type gated clip 44. Of course, the coupling 44 need not be formed by a gated clip, and any other suitable form of releasable connection known in the connection art may be used. The elastic member 60 should be elastically stretchable between a relaxed, at rest state and an extended or stretched state. If desired, a limit cord 62 may be associated with the elastic element 60, such as running down the center thereof, so as limit the maximum extension of the elastic element 60.

The elastic element 60 is suspended from the superstructure cross-member 34 of food bar 20 so as to extend generally downward therefrom. The elastic element 60 may be coupled to the cross-member 34 in a variety of ways. For example, the upper end of the elastic element 60 may be captured by a suitable downwardly extending eyebolt mated to the remainder of the cross-member 34. Alternatively, a suitable coupler 42 may be disposed between the elastic element 60 and the cross-member 34, such as a swiveling eye bolt type gated clip. Regardless, the elastic element 60 is advantageously releasably coupled to the cross-member 34 so that elastic member 60 may be removed therefrom for cleaning when desired.

As indicated above, the utensil assembly 40 may optionally include mounting assembly 70. This mounting assembly 70 advantageously allows the utensil assembly 40 to be readily mounted to the superstructure 30 with very little effort. For example, the mounting assembly 70 may include a magnetic base 72 and an attached eyebolt 74. The magnetic base 72 attaches to the superstructure 30, with the eyebolt 74 extending downward toward the upper surface 24 of the food bar's base 22. Alternatively, a clamping type base may be used, or the base 72 may be attached via suitable bands, or any other connection approach known in the coupling art may be employed. Advantageously, the coupling approach chosen allows the utensil assembly 40 to be mated to existing food bars 20 without requiring any mechanical modification thereto.

As can be seen from the Figures, the utensil assembly 40 allows the serving utensil 50 to be suspended from superstructure 30. When not grasped or otherwise pulled on by a user, the elastic element 60 is in its relaxed state. It is understood that the elastic element 60 is not technically fully relaxed in this state because the elastic element 60 is supporting its own weight, at least some of the weight of the serving utensil 50, and the weight of any intervening couplers 44. Nevertheless, such a state is referred to herein as the relaxed state. With the elastic element 60 in the relaxed state, the handle section 52 of the serving utensil 50 is held suspended in spaced relation from the upper surface 24 of the food bar base 22. Thus, the handle section 52 is further from the upper surface 24 than the serving end section 58. Advantageously, the longitudinal axis 51 of serving utensil 50 forms a slight angle P with vertical, such as from 0°-15°. Thus, the serving utensil 50 is supported so as to be in a substantially vertical orientation when the elastic element 60 is in the relaxed state.

When the user grasps the handle section 52 and pulls on the serving utensil 50, the elastic member 60 is able to elastically deform to an extended (or “stretched”) state. Advantageously, the effective spring constant of the elastic element 60 is relatively small so that the elastic element 60 may be extended with little effort. The elongation of the elastic element 60 to the extended state allows the user to manipulate the serving utensil 50 to serve food 5 from the corresponding food serving station 25. Thus, the elastic member 60 should be designed to allow extension sufficient for a user to reach all relevant areas of the food serving station 25 without undue effort. When the user is finished using the serving utensil 50, the user releases the handle section 52, and the elastic element 60 retracts to the relaxed state, thereby pulling the serving utensil 50 back into the suspended, substantially vertical orientation. Thus, the handle section 52 of the serving utensil 50 is pulled up and away from the food serving station 25 upon release, thereby preventing the handle section 52 from falling into the food 5. Further, the serving utensil 50 is returned to a known position relative to the food serving station 25, such as a centered location, rather than being left in a random location.

The discussion above has generally assumed that the elastic element 60 is a conventional extension coil spring. However, this is not required, and the elastic element 60 may take different forms. For example, the elastic element 60 may be a different type of spring, such as convolute coil, or may be a “bungee” cord, or any other form of elastic element known in the art (e.g., stretchable polymer). Further, while the elastic element 60 may be coupled to the serving utensil 50 and/or superstructure 30 via an intervening coupler 42 (e.g., gated clip), the elastic element 60 may be directly attached to the serving utensil 50 and/or superstructure 30 if desired.

The discussion above has generally been in terms of a single utensil assembly 40 being connected to the food bar 20. However, is should be understood that multiple utensil assemblies 40 may be associated with a single food bar 20, which is particularly advantageous if the food bar 20 has multiple food serving stations 25. Also, while the present invention may be advantageously employed in the context of a self-service food bar environment, such as those found at salad bars and/or buffet style restaurants, the food service bar 20 need not be of the self-service type.

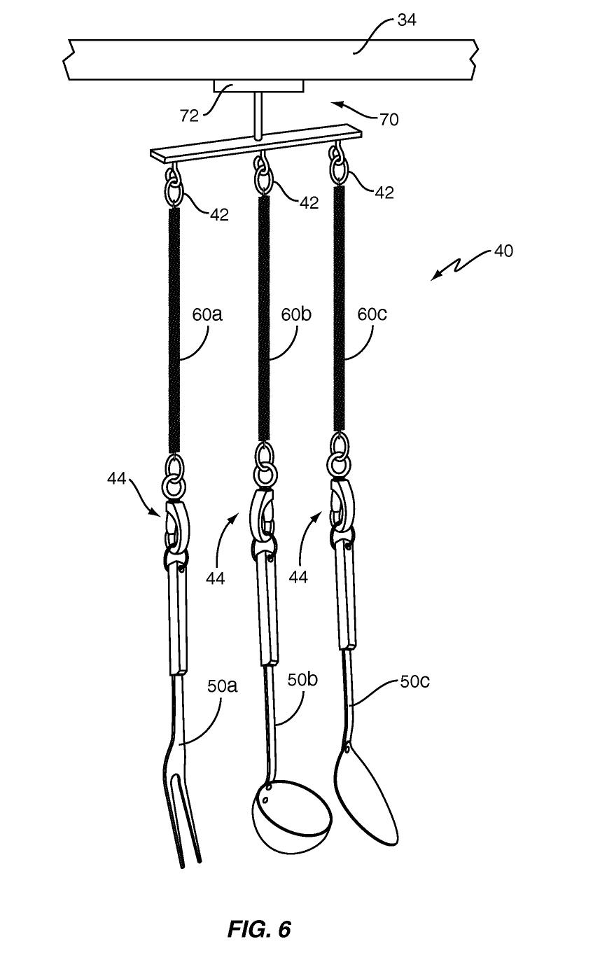

Further, for embodiments employing a mount 70 between the elastic element 60 and the serving utensil 50, the discussion above has, in general, assumed a single serving utensil 50 and elastic element 60 per mount 70. However, in some embodiments, there may be multiple utensils 50 and corresponding elastic elements 60 associated with a single mount 70. For example, the embodiment shown in FIG. 6 has multiple serving utensils (fork 50a, ladle 50b, and spoon 50c) and corresponding elastic elements 60a, 60b, 60c, suspended from cross-member 34 of superstructure 30 via a common hanging mount 70. While believed to be more cumbersome to use, such embodiments may be appropriate for some situations.

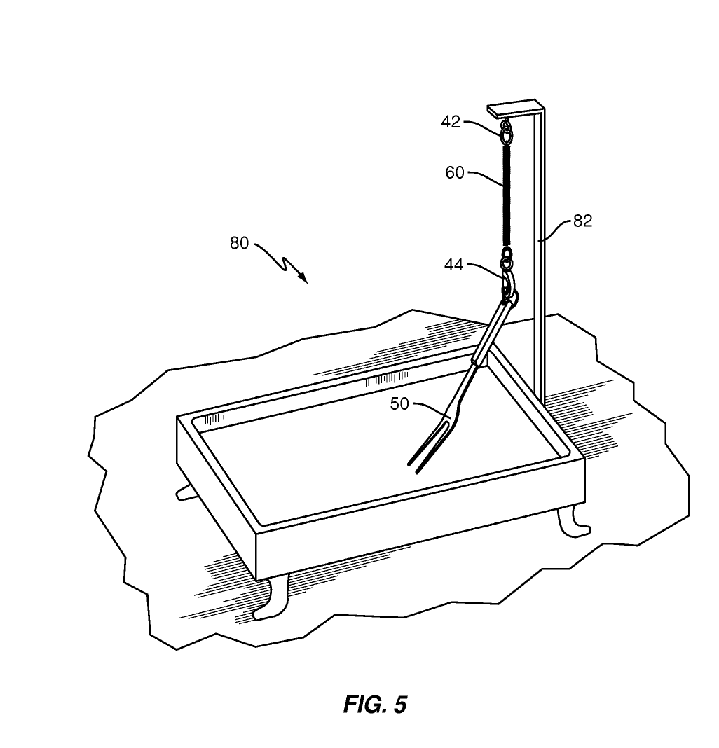

Further still, the discussion above has generally been in terms of the utensil assembly 40 being used in conjunction with a conventional food service bar 20. However, in other embodiments, the utensil assembly 40 may be used in conjunction with other food service apparatus, such as a chafing dish 80. One such embodiment is shown in FIG. 5, where the utensil assembly 40 is associated with a chafing dish 80. For such an embodiment, the superstructure 30 includes an L-shaped bracket 82 that is secured to the base of the chafing dish 80 and extends inward on its upper extent. The utensil assembly 40 is suspended from the superstructure 30. The operation of the utensil assembly 40 in such an embodiment is substantially as described above. Of course, there may be multiple brackets 82 and/or utensil assemblies 40, as is desired. The L-shaped bracket 82 may be secured to the chafing dish 80 in any appropriate manner, such as by welding, bolting, via magnetic mount, or other known mechanical connection means known in the art. Alternatively, the bracket 82 may be free-standing. Further, the bracket 82 may be formed as a rigid piece, or may be formed in a plurality of rigid segments that are hingedly connected together, similar to a carpenter's folding rule.

Advantageously, the components of the food bar 20 and utensil assembly 40 are, where suitable, made from stainless steel or other appropriate material suitable for contact with food. Such materials should also be readily cleanable by conventional means.

The present invention may be carried out in other specific ways than those set forth herein without departing from the scope and essential characteristics of the invention. Further, the various aspects of the disclosed device and associated method may be used alone or in any combination, as is desired. The disclosed embodiments are, therefore, to be considered in all respects as illustrative and not restrictive, and all changes coming within the meaning and equivalency range of the appended claims are intended to be embraced therein.

What is claimed is:

1. A food serving device comprising:
a base having an upper surface having at least a first food container station;
an upper support disposed above said first food container station by a first distance;
a first serving utensil corresponding to said first food container station and having a distal food serving end section and a proximal handle section;
a first elastic element suspended from said support and extending generally downward therefrom; said first elastic element moveably coupling said first serving utensil to said upper support; said first elastic element elastically stretchable from relaxed state to a stretched state in response to a user pulling thereon;
wherein said first elastic element supports said first serving utensil in a suspended fashion such that, with said first elastic element in said relaxed state, said handle section is suspended in spaced relation from said base upper surface so as to be farther from said base upper surface than said serving end section.

2. The device of claim 1 wherein said first elastic element comprises a spring.

3. The device of claim 1 wherein said first serving utensil is selected from the group consisting of a solid serving spoon, a perforated serving spoon, a fork, a ladle, and tongs.

4. The device of claim 1 wherein said upper surface comprises at least a second food container station, and further comprising:
a second serving utensil corresponding to said second food container station and having a distal food serving end section and a proximal handle section;
a second elastic element suspended from said support and extending generally downward therefrom; said second elastic element moveably coupling said second serving utensil to said upper support; said second elastic element elastically stretchable from relaxed state to a stretched state in response to a user pulling thereon;
wherein said second elastic element supports said second serving utensil in a suspended fashion such that, with said second elastic element in said relaxed state, said second serving utensil's handle section is suspended in spaced relation from said base upper surface so as to be farther from said base upper surface than said second serving utensil's serving end section.

5. The device of claim 4 wherein said second serving utensil is of a different type than said first serving utensil.

6. The device of claim 4 further comprising first and second magnetic mounts removably coupling said first and second elastic elements, respectively, to said upper support.

7. The device of claim 1 wherein said upper support is generally horizontally disposed.

8. The device of claim 1 further comprising a magnetic mount releasably connecting said first elastic element to said upper support.

9. The device of claim 1 further comprising a releasable coupler operatively disposed between said first elastic element and said serving utensil.

10. The device of claim 1 wherein said first serving utensil is generally vertically oriented when supported by said first elastic element with said elastic element in said relaxed state.

11. A food serving device comprising:
a food container;
a upper support disposed above said food container by a first distance;
a serving utensil corresponding to said food container and having a distal food serving end section and a proximal handle section;
a elastic element suspended from said support and extending generally downward therefrom; said elastic element moveably coupling said serving utensil to said upper support; said elastic element elastically stretchable from relaxed state to a stretched state in response to a user pulling thereon;
wherein said serving utensil is supported by said elastic element in a suspended fashion such that, with said elastic element in said relaxed state, said handle section is suspended in spaced relation from said food container so as to be farther from said food container than said serving end section.

12. The device of claim 11 wherein said elastic element comprises a spring.

13. The device of claim 11 wherein said first serving utensil is selected from the group consisting of a solid serving spoon, a perforated serving spoon, a fork, a ladle, and tongs.

14. The device of claim 11 wherein said elastic element removably mates to said upper support.

15. The device of claim 11 further comprising a magnetic mount removably coupling said elastic element to said upper support.

16. The device of claim 11 wherein said serving utensil is generally vertically oriented when supported by said elastic element with said elastic element in said relaxed state.

17. The device of claim 11 wherein said serving end section of said serving utensil is disposed in said food container when supported by said elastic element with said elastic element in said relaxed state.

18. The device of claim 11 further comprising a releasable mount coupling said elastic element to said upper support.

19. The device of claim 18 wherein said releasable mount is selected from the group consisting of a magnetic mount, a gated clip, and a swiveling hook.
